(19) United States
(12) Patent Application Publication
(10) Pub. No.: US 2011/0024496 A1
(43) Pub. Date: Feb. 3, 2011

(54) CREDIT CARD, DEBIT CARD OR PREPAID CARD WITH IMPROVED SECURITY FEATURES

(76) Inventor: Keith Herman Nicaise, Statham, MS (US)

Correspondence Address: MICHAEL RIES, 318 PARKER PLACE, OSWEGO, IL, 60543, US

(21) Appl. No.: 12/845,583

(22) Filed: Jul. 28, 2010

Related U.S. Application Data
(60) Provisional application No. 61/229,583, filed on Jul. 29, 2009.

(51) Int. Cl. G06Q 40/00; G06K 19/06; G06K 5/00; H04L 9/00

(52) U.S. Cl. 235/380; 235/493; 380/277

(57) ABSTRACT

The present invention is a credit card, debit card or prepaid card with a front facing and a back facing with improved security features for a user. The card has printed card related indicia on the front facing of the card to allow the user to determine an account associated with the card and a magnetic strip with encrypted information and a plurality of tracking formats disposed on the back facing of the card to prevent reading by a magnetic stripe reader. There is also a separate supplemental card or document supplied to the user to furnish an account number for ordering desired products or services.

This application claims priority to U.S. Provisional Application 61/229,583 filed on Jul. 29, 2009, the entire disclosure of which is incorporated by reference.

### TECHNICAL FIELD & BACKGROUND

There are two highly efficient recommended encryption and transformation techniques for converting original and substitute account numbers. The first encryption technique preserves the length and data type (decimal digits) of the original field. This could be, for example, the Advanced Security Standard (AES). The second encryption technique involves dataset(s) that provide a one-to-one correspondence for all one million six digit numbers from 000000 to 999999. The(se) dataset(s) may be constructed as follows using relative record dataset type(s) such as IBM mainframe VSAM RRDS:
1. Create a sequential data set comprised of the 1,000,000 records that consist of a random number followed by the given number.
2. Sort this dataset with the major key being the random number and the minor key being the six digit value.
3. Read the sorted file and insert records into the relative record dataset such that:
   i. The relative record number of the sorted records are inserted at the relative position specified by the number contained in the sorted data set.
   ii. Either construct a separate relative record data set or increase the relative record count by one million such that the relative record number is that of the sorted record and the record content is the number in the sorted record.
4. To convert from the corresponding six digits of the original account number retrieve the record at the relative record of the account number and use the resulting value as a replacement.
5. To convert from the substitute number back to the original, read the relative record specified by the corresponding digits of that number if there is a separate dataset or increase the relative record number by 1,000,000 and read that record from the combined dataset.

The above procedure could also verify that no account number is mapped to itself and fail the build if this occurs. If smart production equipment could be obtained to download the above translation vector and perform the encryption of the account numbers, then no user software changes could be needed by the credit card companies for producing the encrypted cards. Coupled with the decryption of account numbers on input transactions only minor changes could be required for adoption of the credit card with improved security features. Note that the three digits that precede the SCD may be used to select up to 1000 different encryption processing options, datasets or dataset segments, and/or processing options.

In 2005, an estimated 13.5 percent of U.S. adults (30.2 million consumers) were victims of one or more of cases of identity fraud in the previous year. There were an estimated 48.7 million incidents of these frauds during this one year period. Fraud involving credit and debit cards reached $22 billion in 2008, up from $19 billion in 2007. The security of consumer information came under renewed scrutiny when a 28-year-old Florida man, Albert Gonzalez, was indicted along with two other unnamed hackers for breaching the computer networks of Heartland and Hannaford, both of which said they were in compliance with security requirements. Those standards were set by a council that includes the world's two largest credit card networks, Visa and MasterCard, fast-food leader McDonald's, oil company Exxon Mobil and Bank of America and Royal Bank of Scotland.

The present invention generally relates to a credit card, debit card or prepaid card with improved security features. More specifically, the invention is a credit card, debit card or prepaid card with removed embossed or raised account numbers, a removed security code and encrypted magnetic strip account numbers.

It is also an object of the invention to provide an improved level of security on computer data that is used to validate the credit card, debit card or prepaid card.

It is also an object of the invention to provide a credit card, debit card or prepaid card that prevents methods of stealing account numbers and security codes.

It is also an object of the invention to provide a credit card, debit card or prepaid card that is not only to be designed to be used alone but could also be used as a supplement to payment card industry data security standards.

What is really needed is a credit card, debit card or prepaid card with removed embossed account numbers, a removed security code and an encoded magnetic strip account number for improved security that is not only to be designed to be used alone but could also be used as a supplement to payment card industry data security standards.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of a credit card, debit card or prepaid card front facing with improved security features, in accordance with one embodiment of the present invention.

FIG. 1B illustrates a front perspective view of a credit card, debit card or prepaid card back facing with improved security features, in accordance with one embodiment of the present invention.

FIG. 2 illustrates a flow chart for a method for performing encryption, in accordance with one embodiment of the present invention.

FIG. 3 illustrates a flow chart for a method of using a credit card, debit card or prepaid card with improved security features, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

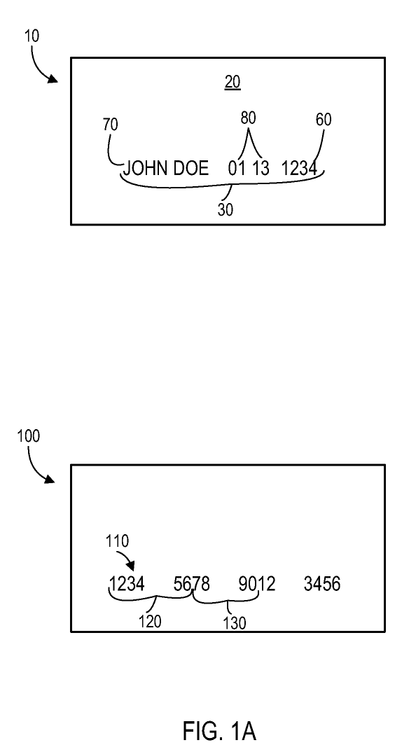

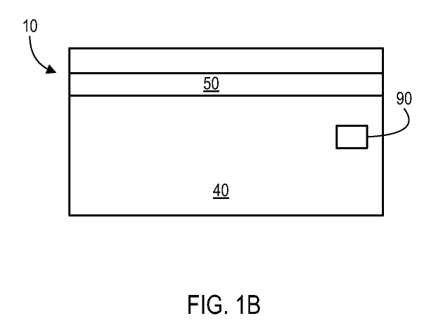

FIG. 1A illustrates a front perspective view of a credit card, debit card or prepaid card 10 with improved security features, in accordance with one embodiment of the present invention. The credit card, debit card or prepaid card 10 has a front facing 20 with printed card related indicia 30 to allow a user (not shown) to determine an account associated with the credit card, debit card or prepaid card 10.

FIG. 1B illustrates a front perspective view of a credit card, debit card or prepaid card with a back facing 40 with improved security features, in accordance with one embodiment of the present invention. The credit card, debit card or prepaid card 10 prevents obvious methods of stealing credit card account numbers and security codes (not shown). This is done by employing two methods. First obsolete embossed or raised print credit card account numbers are removed from the front of the card 20. Second an account number (not shown) can be encrypted on the magnetic strip 50 found on the back facing 40 of the credit card, debit card or prepaid card 10. This leaves the credit card, debit card or prepaid card 10 without any simple way to determine the account number which can be entrusted to third parties such as restaurant personnel with little fear that the account number can be compromised or unauthorizably used.

It is recommended that a single ID number (e.g., the last 4 digits of the account number) 60 be printed (not embossed) on the surface of the credit card, debit card or prepaid card 10 to allow the card holder or user to determine the account associated with the credit card, debit card or prepaid card 10. The card holder or user's name 70 and the expiration date 80 should also be printed and not embossed on the credit card, debit card or prepaid card 10 as well. While the encryption of the magnetic strip 50 information is not required to prevent the simple recording of the card number by visual inspection, it is desirable to prevent reading of the account number by a magnetic stripe reader (not shown). Elimination of this encryption does allow the transaction processing software to remain unchanged, without the burden of decryption.

Traditional credit cards, debit cards and prepaid cards 10 have an area 90 for printing a security code on the back facing, but the credit card, debit card or prepaid card 10 does not print the security code on the back facing 40 or anywhere on the credit card, debit card or prepaid card 10. There is also a magnetic strip 50 with encrypted information and a plurality of tracking formats (not shown) disposed on the back facing 40 of the credit card, debit card or prepaid card 10 to prevent reading by a magnetic stripe reader obtaining an account number off of the magnetic strip 50. A separate supplemental card or document 100 supplied to the user to furnish an account number 110 for ordering desired products or services online or over the phone is also included as part of the credit card, debit card or prepaid card 10.

The encryption code is used to index a specific encryption key selected by the card's issuer. The first six digits of the account number 110 should not be encrypted. These digits are the Issuer Identification Number (IIN(I)) 120 which is used to route a transaction to the proper bank or credit card company.

A magnetic stripe format is provided with a track format of magnetic stripe cards (tracks 1 and 2). It summarize of credit card magnetic stripe' data for Track 1 and Track 2 which is used for financial transactions, and debit cards. Track 2 magnetic stripe data is used for financial transactions, i.e., credit and debit card information is executed from the international standards ISO 7813 (tracks 1 and 2) documentation.

JavaScript code can be used for parsing magstripe Track 1 and Track 2 strings. Track 1 (“International Air Transport Association”) stores more information than Track 2, and contains cardholder's name as well as account number and other discretionary data. This track is sometimes used by airlines when securing reservations with a credit card.

Track 2 (“American Banking Association,”) is currently most commonly used, though credit card companies have been pushing for everyone to move to Track 1. This is the track that is read by ATMs and credit card checkers. The ABA designed the specifications of this track and all world banks must abide by it. It contains the cardholder's account, encrypted PIN, plus other discretionary data.

### *** Track 1 Layout: ***

### |ss|Fe|PAN Name|. FS|Additional Data|ES|LR(

### http://www.acmetech.com/documentation!credit_cardsImagstripe track_format.html 7/29/2009

### Magnetic Stripe Track 1, Track 2 Data Description

### SS=Start Sentinel “%”

### FC=Format Code

### PAN=Primary Acct. # (19 digits max)

### FS=Field Separator “A”

### Name=26 alphanumeric characters max

### Additional Data=Expiration Date, offset, encrypted PIN, etc.

### ES=End Sentinel “?”

### LRC=Longitudinal Redundancy Check

### *** Track 2 Layout: ***

### |ss|PAN|FS|Additional Data|ES|LRC|

### SS=Start Sentinel “;”

### PAN=Primary Acct. # (19 digits max)

### FS=Field Separator “a”

### Additional Data=Expiration Date, offset, encrypted PIN, etc.

### ES=End Sentinel “?”

### LRC=Longitudinal Redundancy Check

### *** Track 3 Layout: ** Similar to tracks 1 and 2. Almost never used

### Many different data standards can be used

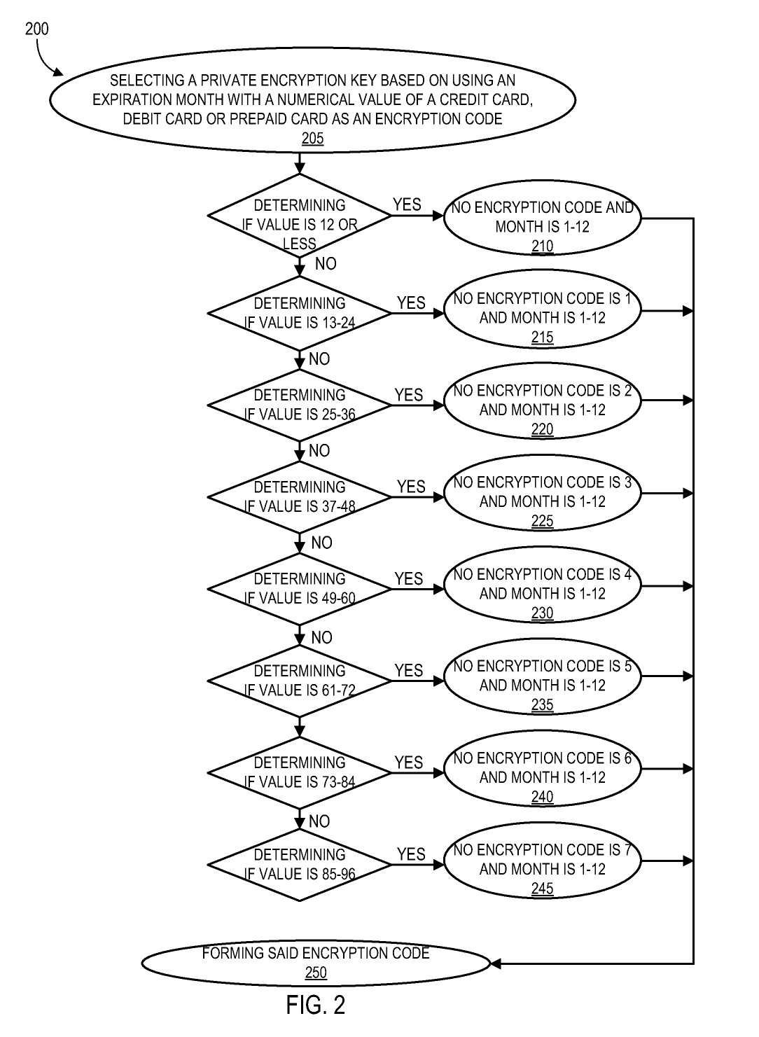

FIG. 2 illustrates a flow chart for a method for performing encryption 200, in accordance with one embodiment of the present invention. There are many ways to perform an encryption that can retain the current magnetic stripe format. The suggested method is to select a private encryption key based on using the month of expiration as a code. The steps include selecting a private encryption key based on using an expiration month with a numerical value of a credit card, debit card or prepaid card as an encryption code 205, determining if said numerical value is 12 or less 210, determining if said numerical value is between 13 and 24 215, determining if said numerical value is between 25 and 36 220, determining if said numerical value is between 37 and 48 225, determining if said numerical value is 49 and 60 230, determining if said numerical value is between 61 and 72 235, determining if said numerical value is between 73 and 84 240, determining if said numerical value is between 85 and 96 245 and forming said encryption code 250.

Another important reason for encrypting the account number 110 is that many thefts are from hackers breaking into merchant's computers and stealing credit card data. If the account number is encrypted on the magnetic stripe it is also encrypted in these files. This report states that 40% of all credit card information theft is from restaurants and that most of this is from hackers and not waiters. This procedure eliminates the obsolete embossed credit card with visual information that can be stolen at any transaction. The credit card, debit card or prepaid card 10 is only machine readable and must be validated by a central computer with the proper encryption code. The credit card, debit card or prepaid card 10 gives up no usable information visually, mechanically or electronically without breaking the encryption.

The information which comes off the credit card, debit card or prepaid card 10 and makes its way into merchant's computer files will be encrypted, so what is stored in those computers will be as secure as what is on the card 10. Anyone who hacks into these files will come away with useless information. This leaves a credit card without any simple way to determine the account number which can be entrusted to third parties such as restaurant personnel with little fear that the credit card account number can be compromised.

The credit card, debit card or prepaid card 10 requires the encryption to be performed when the card is produced and the decryption at the beginning when the encrypted data is input from magnetic stripe scanners. All other processing remains unchanged. All external transactions are performed with the encrypted account number. A special procedure, similar to the existing PCI DSS mechanism allows manual input of transactions as well.

The first six digits of the account number should not be encrypted. These digits are the Issuer Identification Number (IIN) 120 which is used to route transaction to the proper bank or credit card company. Also the three digits following the IIN 120 are the self-checking digits 130 (SCD) that remain unchanged and is used to specify encryption parameters, data sets, or even different processing methods. The SCD 130 is recomputed for the substitute account number. However it is recommended that special IINs 120 be dedicated to specified accounts. This would identify that the account number needs to be encrypted/decrypted and eliminate the need to add a bit flag to the magnetic stripe data as specified below.

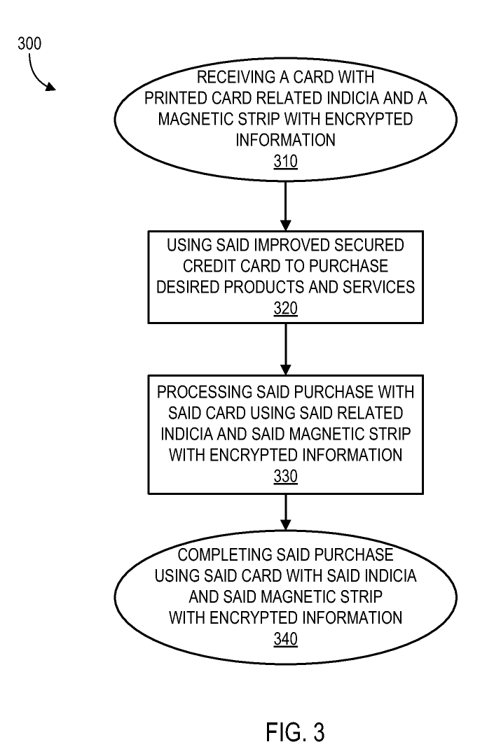

FIG. 3 illustrates a flow chart for a method of using a credit card, debit card or prepaid card with improved security features 300, in accordance with one embodiment of the present invention. The steps for the method 300 are receiving the improved card with printed card related indicia and a magnetic strip with encrypted information 310, using the improved secured card to purchase desired products and services 320, processing the purchase with the card using the printed card related indicia and magnetic strip with encrypted information 330 and completing the purchase using the card with the printed card related indicia and the magnetic strip with encrypted information 340. The method 300 includes printed card related indicia that is not embossed, but rather printed. The method 300 further includes the magnetic strip that is encrypted with an expiration month with a numerical value of a credit card, debit card or prepaid card as an encryption code.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A credit card, debit card or prepaid card with a front facing and a back facing with improved security features for a user, comprising:
printed card related indicia on said front facing of said card to allow said user to determine an account associated with said card;
a magnetic strip with encrypted information and a plurality of tracking formats disposed on said back facing of said card to prevent reading by a magnetic stripe reader; and
a separate supplemental card or document supplied to said user to furnish an account number for ordering desired products or services.

2. The credit card according to claim 1, wherein said credit card related indicia is not embossed.

3. The credit card according to claim 1, wherein said card related indicia include said user's name, expiration date of said card and a plurality of identification numbers.

4. The credit card according to claim 3, wherein said identification numbers are last 4 digits of said user's account number.

5. The credit card according to claim 3, wherein a first six digits of said user's account number are not encrypted.

6. The credit card according to claim 1, wherein said encrypted information includes said user's account number.

7. The credit card according to claim 1, wherein said products or services are ordered by phone or the Internet.

8. A method for performing encryption, comprising:
selecting a private encryption key based on using an expiration month with a numerical value of a credit card, debit card or prepaid card as an encryption code;
determining if said numerical value is 12 or less;
determining if said numerical value is between 13 and 24;
determining if said numerical value is between 25 and 36;
determining if said numerical value is between 37 and 48;
determining if said numerical value is 49 and 60;
determining if said numerical value is between 61 and 72;
determining if said numerical value is between 73 and 84;
determining if said numerical value is between 85 and 96; and
forming said encryption code.

9. The method according to claim 8, wherein said encryption code is used to index said encryption key selected by said user.

10. The method according to claim 8, wherein no said encryption code is provided when said numerical value is 12 or less.

11. The method according to claim 8, wherein said encryption code is 1 and said expiration month is between 1 and 12 when said numerical value is between 13 and 24.

12. The method according to claim 8, wherein said encryption code is 2 and said expiration month is between 1 and 12 when said numerical value is between 25 and 36.

13. The method according to claim 8, wherein said encryption code is 3 and said expiration month is between 1 and 12 when said numerical value is between 37 and 48.

14. The method according to claim 8, wherein said encryption code is 4 and said expiration month is between 1 and 12 when said numerical value is between 49 and 60.

15. The method according to claim 8, wherein said encryption code is 5 and said expiration month is between 1 and 12 when said numerical value is between 61 and 72.

16. The method according to claim 8, wherein said encryption code is 6 and said expiration month is between 1 and 12 when said numerical value is between 73 and 84.

17. The method according to claim 8, wherein said encryption code is 7 and said expiration month is between 1 and 12 when said numerical value is between 85 and 96.

18. A method of using an improved secured credit card, debit card or prepaid card, comprising:
receiving said improved card with printed card related indicia and a magnetic strip with encrypted information;
using said improved secured card to purchase desired products and services;
processing said purchase with said card using said printed card related indicia and said magnetic strip with encrypted information; and
completing said purchase using said card with said printed card related indicia and said magnetic strip with encrypted information.

19. The method according to claim 18, wherein said printed card related indicia are not embossed.

20. The method according to claim 18, wherein said magnetic strip is encrypted with an expiration month with a numerical value of a credit card, debit card or prepaid card as an encryption code.
